(19) United States
(12) Patent Application Publication
(10) Pub. No.: US 2004/0112548 A1
(43) Pub. Date: Jun. 17, 2004

(54) Shade for an arched window

(76) Inventors: David R. Militello, Rohnert Park, CA (US); Barry L. Shevick, Fair Oaks, CA (US)

Correspondence Address: Bradley P. Heisler, Heisler & Associates, Suite 300, 3017 Douglas Blvd., Roseville, CA, 95661, US

(21) Appl. No.: 10/318,975

(22) Filed: Dec. 12, 2002

(51) Int. Cl. E06B 3/48

(52) U.S. Cl. 160/84.07

(57) ABSTRACT

An assembly is provided to shade an arched window. The assembly includes a shade portion preferably in the form of a pleated shade extending between a first end and a second end. The ends of the shade are positioned so that the shade portion takes on a fanned configuration of semi-circular form similar to that of the arched window. A retainer is provided as a support to hold the shade in a vertical orientation adjacent the window. The retainer includes a guide in the form of at least one panel extending up from a horizontal base resting upon a sill below the window. The panel buttresses the shade to keep the shade in the vertical orientation shading the arched window.

### FIELD OF THE INVENTION

The following invention relates to shades for at least partially occluding the passage of light through a window. More particularly, this invention relates to shades and shade supporting structures for a window that is arched.

### BACKGROUND OF THE INVENTION

In addition to decorative window treatments, it is often desirable to have some form of shade or blind installed adjacent to a window to prelude or diminish the amount of light passing through the window. With most windows having a square or rectangular form, correspondingly square or rectangular shades can be installed adjacent the window, typically within a recess above a sill in which the window is located, to conveniently cover the window as desired.

Some windows are known in the prior art which include a horizontal lower edge adjacent a sill and an arched upper edge. Most typically, such arched windows are generally in the form of a half circle. Typical rectangular shades are ineffective in shading the passage of light through such arched windows.

While fabric or other materials can be custom cut to shade such arched windows, such solutions involve significant complexity and expense. Accordingly, a need exists for a shade configured particularly for deployment within an arched window which can function as a temporary or permanent shade structure for the window and which can fit a variety of different arched window sizes with little or no modification.

### SUMMARY OF THE INVENTION

With this invention a shade is provided that is particularly configured for deployment within an arched window. The shade assembly includes a rectangular pleated shade with sufficient length between a first end and a second end so that the ends can be rotated into a common plane (i.e. horizontal) and with the pleated shade extending in a fanned configuration between the ends. A retainer is provided to hold the shade in the fanned configuration. Particularly, the retainer includes a base and at least one panel or other guide extending up from the base and substantially parallel with the window. The fanned shade can thus be placed upon the base and adjacent the panel with the retainer keeping the shade from tipping out of a vertical orientation located adjacent to the arched window when the retainer and shade rest upon the sill. The ends of the shade and the base are typically provided with adhesive or other fasteners to secure the shade and retainer together and to the sill.

While the invention is primarily illustrated in the form of a pleated shade of continuous material, the retainer can be used with alternate shades such as those formed from a series of separate slats joined together by a string so that the slats can be oriented in a fanned configuration. Similarly, the slats can be joined together by fabric, such as is commonly provided with a standard expandable hand-held fan.

Also, in one form of the invention a shelf is provided which can adhere directly to the glass of the window, particularly for use with windows that have no sill or windows of a domed style with a semi-circular upper end but a rectangular lower end. The shelf functions as a sill upon which the retainer and shade can be deployed for placement adjacent the semi-circular upper portion of such a domed window. The shelf can also support a rectangular shade or blind extending down from the shelf to cover the lower rectangular portion of a domed window.

### OBJECTS OF THE INVENTION

Accordingly, a primary object of the present invention is to provide a shade for a window which has a semi-circular form for use with arched windows.

Another object of the present invention is to provide an arched window shade which is adjustable in size to fit arched windows of different sizes.

Another object of the present invention is to provide an arched window shade which has an attractive appearance which is similar to the appearance of pleated shades.

Another object of the present invention is to provide a shade for a window which includes an at least partially domed upper portion.

Another object of the present invention is to provide a shade for an arched window which is easy to adjust in size and to position securely in a temporary or permanent fashion adjacent a window.

Other further objects of the present invention will become apparent from a careful reading of the included drawing figures, the claims and detailed description of the invention.

### BRIEF DESCRIPTION OF THE DRAWINGS

FIGS. 1-3 are perspective views of an arched window within a wall and with the shade assembly of this invention shown in various stages of deployment in each of the figures.

FIG. 4 is a perspective view of the shade assembly of this invention, shown fully deployed.

FIG. 5 is a perspective view of the shade portion of this invention before deployment and illustrating the rule and adhesive utilized to properly size and attach the shade portion of this invention.

FIG. 6 is a perspective view of a retainer portion of this invention and with part of the shade portion of this invention shown installed therein.

FIG. 7 is a full sectional view of the retainer of FIG. 6.

FIG. 8 is an end elevation view of the retainer of FIG. 6.

FIG. 9 is a top plan view of the retainer of FIG. 6.

FIG. 10 is a perspective view of an alternative shade in use along with the retainer and installed within a window.

FIG. 11 is a front elevation view of the shade assembly of this invention as part of an overall domed window shade assembly installed within a domed window in a wall and including a shelf with a rectangular shade extending down from the shelf and the shade assembly of FIGS. 1-9 resting upon the shelf.

FIG. 12 is a sectional view taken along line 12-12 of FIG. 11 and illustrating details of the shelf attachable to the glass of the window to support the domed window shade assembly.

### DESCRIPTION OF THE PREFERRED EMBODIMENT

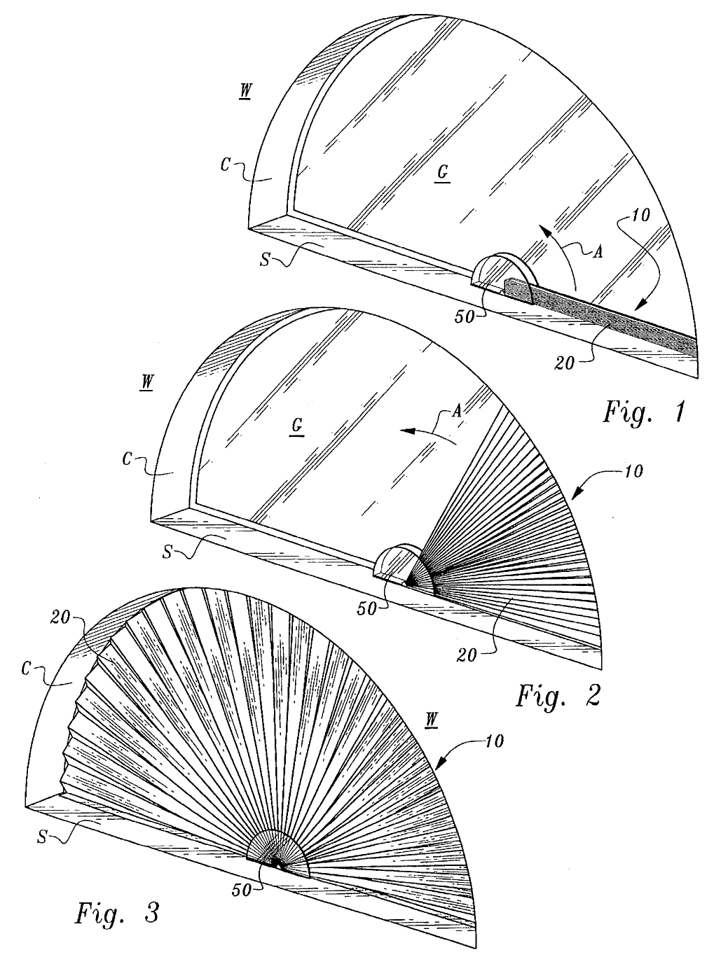

Referring to the drawings, wherein like reference numerals represent like parts throughout the various drawing figures, reference numeral 10 is directed to an assembly including a shade 20 and a retainer 50 (FIGS. 1-4) to provide a shade for an arched window according to this invention. The arched window is typically located within a planar wall W (FIGS. 1-3) with a horizontal sill S below the glass G of the window and a curving ceiling C extending in an arched fashion up from the sill S over the window space and back down to the sill S. The assembly 10 is supported upon the sill S and provides for occlusion of at least a portion of light passing through the glass G of the window when deployed.

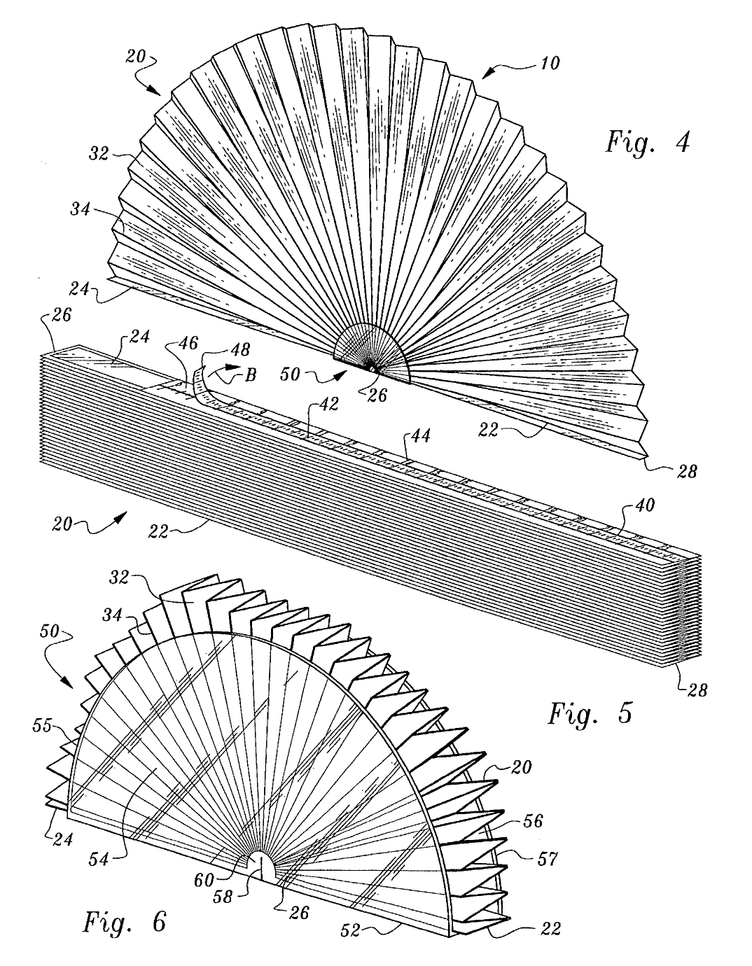

In essence, and with particular reference to FIGS. 1-3, the basic details of the assembly 10 are described. The assembly includes the shade 20 and the retainer 50. The shade 20 can be any of a variety of different shades which are capable of being expanded in length, with the standard pleated shade 20 shown according to the preferred embodiment of this invention. The shade 20 can be fanned, such as by motion of a first end 24 (FIG. 4) away from a second end 22 along arrow A (FIGS. 1-3) so that the pleated shade 20 assumes a semi-circular form. A rule 40 (FIG. 5) is provided on at least one of the ends 22, 24 of the shade 20. A user can utilize the rule 40 after measuring a radius of the window to cut the shade 20 to the appropriate size before deployment adjacent the window as shown in FIGS. 1-3.

The retainer 50 (FIG. 6) is a rigid structure which holds the shade 20 sufficiently so that the shade 20 does not buckle or fall off of the sill S. The retainer 50 preferably includes a base 52 adapted to extend horizontally and with guides preferably in the form of a front panel 54 and rear panel 56 extending vertically up from the base 52. A slot between the panels 54, 56 is wide enough to accommodate a thickness of the shade 20 between the panels 54, 56. Adhesive 46, 53 (FIGS. 5 and 9) can be provided on the base 52 of the retainer 50 and on the ends 22, 24 of the shade 20 to secure the shade 20 to the retainer 50 and to the sill S, and to secure the base 52 of the retainer 50 to the sill S, so that the assembly 10 remains in the desired position adjacent the window.

More specifically, and with particular reference to FIG. 4, particular details of the shade 20 of the assembly 10 of this invention are described. While the shade portion of this invention can take on a variety of different forms, most preferably the shade is provided in the form of a standard pleated shade 20. The preferred shade 20 includes a first end 24 spaced from a second end 22 and with an inside edge 26 and outside edge 28 extending from the first end 24 to the second end 22. The ends 22, 24 are generally parallel to each other and spaced apart. This spacing between the ends 22, 24 is variable depending upon the amount of expansion which is being experienced by the shade 20.

The inside edge 26 and outside edge 28 are typically parallel to each other when the shade 20 is in a collapsed form. The edges 26, 28 are spaced apart by a width of the shade 20. This width remains substantially constant whether the shade 20 is collapsed (FIG. 5) or deployed (FIG. 4). If the shade 20 is expanded a greater amount of expansion adjacent the outside edge 28 than it is adjacent the inside edge 26, the shade 20 will take on a curving form. In such a curving form the inside edge 26 and outside edge 28 maintain their constant distance away from each other but are no longer parallel. By providing the shade 20 in a form sufficiently long between the ends 22, 24 the shade 20 can be fanned into a semi-circle (FIG. 4). Such a semi-circle fanned configuration for the shade 20 is preferred for use according to this invention.

If the shade 20 is sufficiently long between the first end 24 and second end 22 the shade 20 could be fanned to form a complete circle or fanned a greater or lesser amount. Preferably, and according to a preferred form of this invention, the shade 20 is configured to conveniently be fanned into a semi-circular form for use adjacent an arched window having a similar semi-circular form. This invention is appropriately modifiable for use in situations where a window has a greater or lesser portion of a circle to be covered by the assembly 10.

The shade 20 specifically includes a series of rectangular planar surfaces 32 which are joined together by pleats 34. The surfaces are entirely planar when the shade 20 is collapsed (FIG. 5), but actually twists slightly when the shade 20 is fanned. This slight twist of up to ninety degrees is considered to be substantially planar.

The pleats 34 connect adjacent planar surfaces 32 from alternating edges thereof, such that the overall pleated shade 20 takes on a “zig-zag” configuration. The shade 20 can be formed from a variety of different materials, as is known in the art. If the shade 20 is formed of a plastic material, the pleats 34 are typically formed along with the original formation of the shade or are provided in a separate process such as by a heat welding process or an ultrasound welding process to form the pleat into the shade. If the shade 20 is formed of a fabric material, the pleats 34 can be provided in any fashion typically provided in the formation of pleats in textile fabric materials.

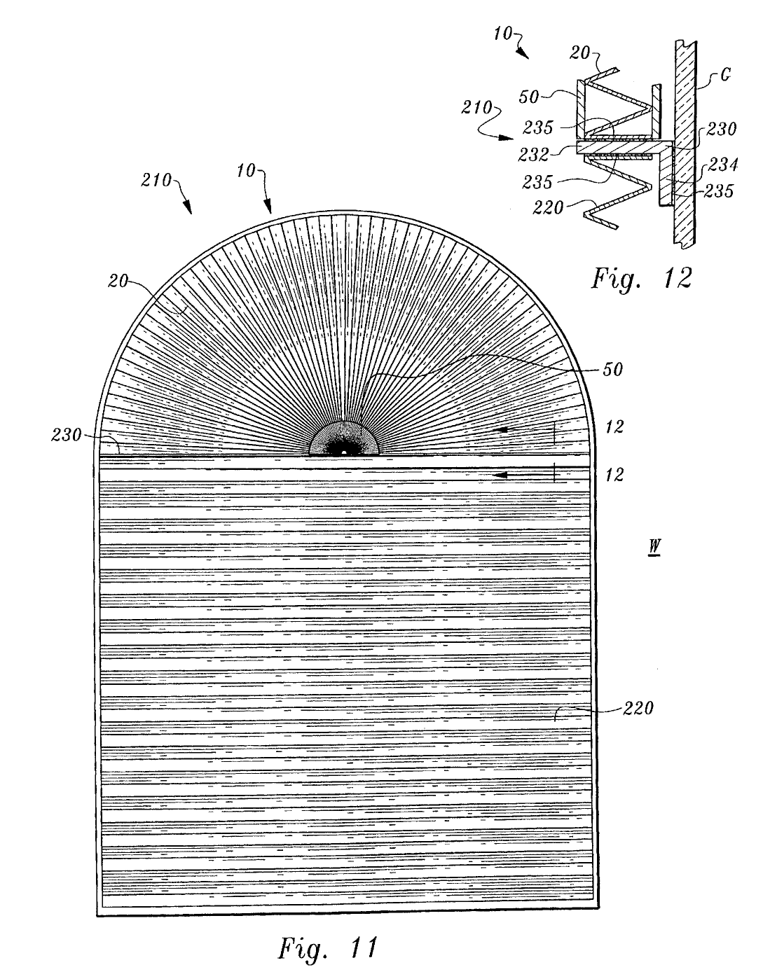

While the shade 20 is preferably in the form of a pleated continuous material (FIGS. 4 and 5), the shade portion of the assembly 10 of this invention can alternatively take on other forms, as are known in the art for occluding the passage of light through windows. For instance, and as shown in FIG. 10, one example of such an alternative shade 120 is provided. With this alternative shade 120, a series of slats 122 are provided adjacent each other with a cord 124 joining adjacent slats 122 together, near a peripheral edge of each of the slats 122. The slats 122 can maintain a perpendicular orientation relative to the window glass or can be twisted or oriented parallel with the window glass, depending upon the aesthetic desires of the user. Typically, the slats 122 would all be joined together adjacent where the retainer 50 is utilized to hold the alternate shade 120 in position.

As an alternative to the cord 124, fabric could be provided to join the slats 122 together, such as in the basic form provided with an expandable hand-held fan. Also, various different expandable shades with various different pleat patterns other than those shown in FIG. 4, but known in the art, could be utilized according to this invention. The pleated shade 20 shown in FIG. 4 provides a preferred form of a means to allow the shade to be adjusted in length and formed into a fanned configuration. The alternate shade 120 of FIG. 10 and the other alternate shades described herein provide other alternative means to adjust the distance that the first end is spaced from the second end of the shade, and to provide for the fanned configuration for use of the shade with the retainer 50 or other support according to this invention.

With particular reference to FIG. 5, details of the rule 40 on the shade 20 are described. The rule 40 includes a series of gradations 42 (i.e. lines or other generally linear markings) extending along at least a portion of the thickness of the shade 20, preferably adjacent both the first end 24 and second end 22. Indicia 44, preferably in the form of numbers, are provided adjacent at least some of the gradations 42 to identify the gradations 42. Preferably, a rule 40 is provided on both the first end 24 and the second end 22. While the rule 40 can be identical on both the first end 24 and second end 22, preferably English units of measurement are provided on the rule 40 on the first end 24 and metric units of measurement are provided on the rule 40 on a second end 22.

Uniquely, the gradations 41 and indicia 44 of the rule 40 are distorted slightly from a true measurement of a width of the shade 20 from the inside edge 26 to the outside edge 28. Specifically, the rule 40 is shifted a slight amount toward the inside edge 26. This slight amount matches a radius of the hump 60 within the retainer 50, described in detail below. Because the hump 60 causes the inside edge 26 of the shade 20 to be slightly raised above the sill S, the user avoids the complexity of subtracting out the height of the hump 60 when properly measuring and cutting the shade 20.

For instance, if the hump 60 has a radius of a half inch, the rule 40 is provided with the gradations 42 and corresponding indicia 44 shifted one half inch toward the inside edge 26. Hence, by way of example, the number “20” would be an indicia 44 adjacent a gradation 42 which would in actuality be 19.5 inches away from the inside edge 26 of the shade 20. When a user cuts the shade 20 at the gradation 42 adjacent the “20” indicia 44 the shade 20 will have been cut to have a width between the inside edge 26 and the outside edge 28 which is 19.5 inches. When the shade 20 is later deployed adjacent the retainer 50, the hump 60 will raise the shade 20 by a half inch so that the shade will actually have a height of 20 inches above the sill. Preferably, the rule 40 is also shifted additionaly slightly (i.e. one fourth of an inch) to accommodate thickness of the base 52 of the retainer 50 and to provide a margin of clearance for the shade 20. Hence, a user merely measures a height of the window and then cuts the shade 20 at the indicia 44 which matches the measurement made of the window height.

Preferably, either a portion or all of the rule 40 is provided upon a backing strip 48 which protects an adhesive 46 on the first end 24 and second end 22. Hence, after the shade 20 has been cut, the backing strip 48 can be removed to expose adhesive 46 underneath for securing the ends 22, 24 to a base 52 of the retainer 50 and to the sill S. In this way, the shade 20 is securely held to the retainer 50 and to the sill S when deployed. Other fasteners could similarly be utilized including tacks or other mechanical fasteners or a user could provide a separate adhesive, such as glue or paste, or utilize adhesive tape, or any other fastening means.

With particular reference to FIGS. 6-9, details of the retainer 50 are described. The retainer 50 is a preferred form of a support which provides a means for holding the shade 20 in a fanned configuration within a substantially vertical plane adjacent the window to be covered by the assembly 10 of this invention. In the preferred form of this invention, the retainer 50 is a rigid construct formed from a unitary mass of material, such as injection moldable plastic. The retainer 50 is preferably made of transparent or partially transparent plastic.

The retainer 50 includes a planar base 52 adapted to rest horizontally upon the sill S. The base 52 includes a guide, preferably in the form of a front panel 54, extending vertically up from one edge of the base 52 and an optional but preferred second guide in the form of a rear panel 56 extending vertically up from an opposite edge of the base 52. An adhesive region 53 (FIG. 9) can be provided on the base 52 to secure the base 52 to the sill S. The front panel 54 preferably is shaped to extend up to a semi-circular rim 55. Similarly, the rear panel 56 is preferably shaped to extend up to a semi-circular rim 57. Such a semi-circular form for the panels 54, 56 cause the retainer 52 to provide the required amount of lateral support so that the shade 20 does not buckle and bend out of the retainer 50. The panels 54, 56 thus provide a means to buttress the shade 20 to keep the shade 20 in a vertical orientation adjacent the window. The retainer thus provides a means to hold the shade 20 in the fanned configuration adjacent the window. A centerline 58 is preferably provided at a center of the front panel 54 to assist in properly positioning the retainer 50 at a center point of the window.

While the panels 54, 56 provide a preferred form of guide to buttress the shade 20, other guides could be provided to provide such lateral support and buttressing of the shade 20. Specifically, rather than providing panels 54, 56 which are continuous in form, guides which merely provide support adjacent the rims 55, 57, such as in the form of rigid wires could be effective. Also, panels or other structures of various different geometries could be provided, or of various different sizes. At a minimum, the guide of the retainer 50 or other support must merely provide lateral support at a position sufficiently far above the inside edge 26 of the shade 20 so that the shade 20 can maintain the deployed fanned configuration adjacent the window without buckling or tipping away from the window.

While the retainer 50 preferably is provided with both a front panel 54 and rear panel 56 or other pair of guides, the retainer 50 could function with only the front panel 54 or only the rear panel 56, or other single guide. In such a single guide configuration, the front panel 54 or other guide would extend vertically up from the base 52 and the base 52 would be located sufficiently close to the glass G of the window so that the shade 20 can be supported between the front panel 54 or other guide and the glass G of the window. Alternatively, the single guide could be attached to the shade 20 to reside on either side of the shade 20. The rear panel 56 is thus not strictly required for the retainer 50, but rather it is preferred to provide the greatest flexibility in positioning of the shade 20 at a desired distance away from the glass G of the window.

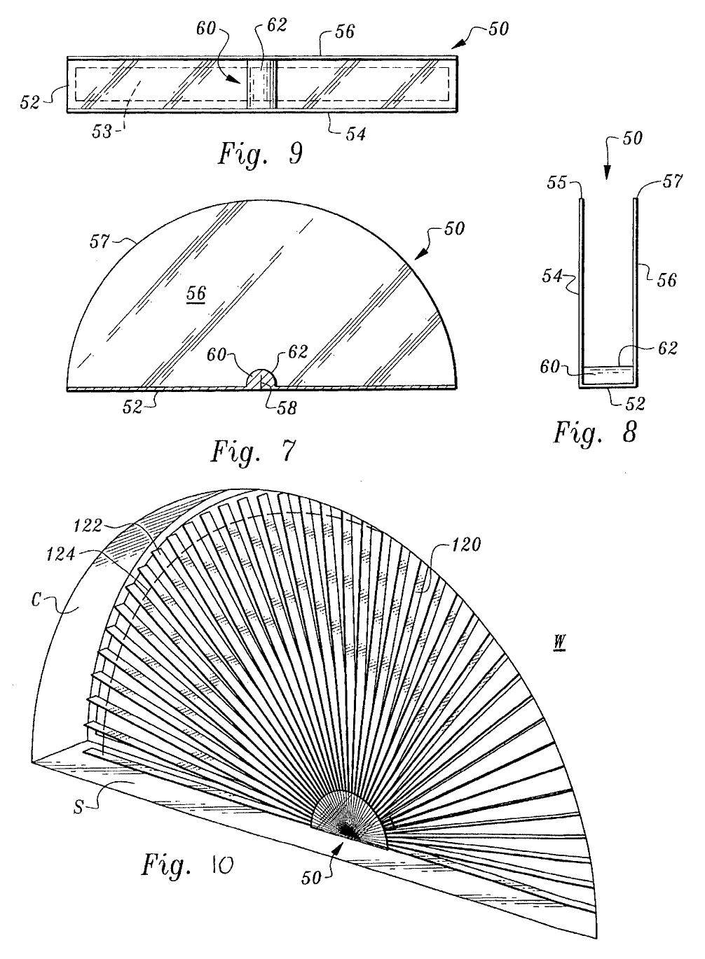

When the shade 20 is configured in the fanned configuration, the inside edge 26 of the shade 20 remains in a tightly focused curve. However, the inside edge 26 does not occupy merely one point in space. Rather, it passes along a curved surface having a perimeter length similar to a height of the shade 20 when in the collapsed configuration. To provide adequate support and uniform deployment of the shade 20 in the fanned configuration, a hump 60 is preferably provided extending up from a center of the base 52 and providing a curved top surface 62 against which the inside edge 26 of the shade 20 can rest. This curved surface 62 of the hump 60 is preferably circular in cross-section (FIG. 7).

While the hump 60 is preferably a solid structure, the hump 60 can merely be in the form of one or more circular ribs having the cross-sectional contour similar to that shown in FIG. 7.

Often an arched window is not perfectly semi-circular in form, but rather has an upper edge which is of slightly shorter radius at a maximum height portion and of slightly greater radius adjacent the sill S. Other arched window configurations are also conceivable, such as where the arched window will be taller than one half of the width adjacent the sill S. To accommodate such variation in arched window configurations, the hump 60 can be provided with a curved surface 62 which corresponds with such non-circular anomalies in the arched window. In this way, the shade 20 can be caused to more closely match the geometry of an arched window of non-circular form. Alternatively, the hump 60 can remain circular and the inside edge 26 of the shade 20 can be placed and adhered to the base 50 at a location slightly spaced from the hump 60 so that the outside edge 28 maintains a desirable constant small spacing from the ceiling C (FIGS. 1-3) arching over the sill S. The hump 60 or alternative ribs described above thus provide one means for causing the shade 20 to exhibit a fanned configuration with a geometry which matches a geometry of the arched window.

With particular reference to FIGS. 11 and 12, details of a domed window shade assembly 210 of this invention for use with a domed window are described. Domed windows are known which include a semi-circular or other arched form at an upper portion of the window, and typically with a generally rectangular form below the arched portion of the window. As particularly shown in FIG. 12, a shelf 230 is provided which is preferably attached directly to the glass G of the window. The shelf 230 includes a ledge 232 which is planar and extends horizontally similar to the sill S of the arched window of FIGS. 1-3.

The retainer 50 and shade 20 of the preferred embodiment of this invention can rest upon or be adhesively attached to the ledge 232 of the shelf 230 so that the shade assembly 10 is provided adjacent the arched upper portion of the domed window. A foot 234 extends vertically down from the ledge 232. Adhesive 235 secures the foot 232 directly to the glass G. Alternatively, the shelf 230 could be fastened to sides of a recess in the wall W for proper support of the ledge 232. Adhesive 235 is similarly utilized to secure the retainer 50 and shade 20 upon the ledge 232 of the shelf 230.

The remainder of the domed window which is generally rectangular can be at least partially occluded with a standard rectangular shade 220 having a width similar to a width of the lower portion of the domed window. The rectangular shade 220 of approximately twice the width of the shade 20 can be adhesively attached to an undersurface of the ledge 232 and depend down from the shelf 230 to occlude the rectangular portions of the window below the arched portions of the domed window above the shelf 230. In this way, an overall occlusion of light passing through such a domed window can be achieved.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

What is claimed is:

1- An apparatus for occluding at least a portion of light passing through a window, comprising in combination:
a shade having a first end adapted to be spaced a variable distance from a second end and an inside edge and an outside edge defining sides of said shade from said first end to said second end; and
a support having a horizontal base and at least one guide extending up from said base and adapted to hold said shade when said shade is deployed within a vertical plane and in a fanned configuration with said first end and said second end oriented horizontally and substantially co-planar and at least partially adjacent said base with said inside edge of said shade adjacent said support.

2- The apparatus of claim 1 wherein said shade includes a continuous structure from said first end to said second end including linear pleats extending from said inside edge to said outside edge with substantially planar surfaces between adjacent said linear pleats.

3- The apparatus of claim 2 wherein said shade is formed at least partially of a textile fabric.

4- The apparatus of claim 2 wherein said shade is formed at least partially from a plastic material.

5- The apparatus of claim 1 wherein said shade includes separate slats of rigid material extending from said inside edge to said outside edge.

6- The apparatus of claim 1 wherein said support includes at least two guides oriented parallel to each other with a slot therebetween.

7- The apparatus of claim 6 wherein said support is in the form of a retainer with said at least two guides configured as front and rear panels of rigid material extending vertically up from said horizontal base.

8- The apparatus of claim 7 wherein said front panel and said rear panel each include curved rims defining uppermost portions of each of said panels.

9- The apparatus of claim 7 wherein at least one of said front and rear panels is formed of an at least partially transparent material.

10- The apparatus of claim 9 wherein a hump is located upon said base and between said front panel and said rear panel at a midpoint between ends of said base extending between said front panel and said rear panel, said hump having a surface raised above said base.

11- The apparatus of claim 10 wherein said hump includes a top surface having a circular cross-section.

12- The apparatus of claim 10 wherein said top surface of said hump has a curving cross-section exhibiting a curve which corresponds with a curve exhibited by the window to be shaded by said apparatus.

13- The apparatus of claim 6 wherein said shade includes a continuous structure from said first end to said second end including linear pleats extending from said inside edge to said outside edge with substantially planar surfaces between adjacent said linear pleats.

14- The apparatus of claim 13 wherein said shade is formed at least partially of a textile fabric.

15- The apparatus of claim 13 wherein said shade is formed at least partially from a plastic material.

16- The apparatus of claim 6 wherein said shade includes separate slats of rigid material extending from said inside edge to said outside edge.

17- The apparatus of claim 1 wherein a hump is located upon said base at a midpoint between ends of said base, said hump having a surface raised above said base.

18- The apparatus of claim 17 wherein said hump includes a top surface having a circular cross-section.

19- The apparatus of claim 17 wherein said top surface of said hump has a curving cross-section exhibiting a curve which corresponds with a curve exhibited by the window to be shaded by said apparatus.

20- The apparatus of claim 1 wherein said support is in the form of a retainer having said at least one guide in the form of a front panel, said front panel extending vertically up from an edge of said base most distant from the window, said base having a width at least as great as a width of said shade, such that said shade can be located between said front panel and said window.

21- The apparatus of claim 20 wherein said front panel includes a curved rim defining an uppermost portion of said front panel.

22- The apparatus of claim 20 wherein said retainer includes a rear panel extending vertically up from an edge of said base opposite said front panel with said rear panel parallel with said front panel and spaced from said front panel by a distance at least as great as a thickness of said shade.

23- The apparatus of claim 20 wherein said front panel is formed of at least partially transparent material.

24- The apparatus of claim 20 wherein said shade includes a continuous structure from said first end to said second end including linear pleats extending from said inside edge to said outside edge with substantially planar surfaces between adjacent said linear pleats.

25- The apparatus of claim 24 wherein said shade is formed at least partially of a textile fabric.

26- The apparatus of claim 24 wherein said shade is formed at least partially from a plastic material.

27- The apparatus of claim 20 wherein said shade includes separate slats of rigid material extending from said inside edge to said outside edge.

28- An arched window shade apparatus, comprising in combination:
a shade having a first end adapted to be spaced a variable distance from a second end; and
a support having at least one guide adapted to hold said shade adjacent at least a portion of said first end and said second end while said shade is deployed within a plane and in a fanned configuration.

29- The apparatus of claim 28 wherein said shade includes a continuous structure from said first end to said second end including linear pleats extending from said inside edge to said outside edge with substantially planar surfaces between adjacent said linear pleats.

30- The apparatus of claim 28 wherein said support includes at least two guides oriented parallel to each other with a slot therebetween.

31- The apparatus of claim 30 wherein said support is in the form of a retainer with said at least two guides configured as front and rear panels of rigid material extending vertically up from a horizontal base.

32- The apparatus of claim 31 wherein a hump is located upon said base and between said front panel and said rear panel at a midpoint between ends of said base extending between said front panel and said rear panel, said hump having a surface raised above said base.

33- The apparatus of claim 28 wherein said support is in the form of a retainer having said at least one guide in the form of a front panel, said front panel extending vertically up from an edge of a horizontal base most distant from the window, said base having a width at least as great as a width of said shade, such that said shade can be located between said front panel and said window.

34- The apparatus of claim 33 wherein said retainer includes a rear panel extending vertically up from an edge of said base opposite said front panel with said rear panel parallel with said front panel and spaced from said front panel by a distance at least as great as a thickness of said shade.

35- The apparatus of claim 28 wherein said shade includes separate slats of rigid material extending from said inside edge to said outside edge.

36- A shade assembly for placement adjacent a window, and particularly an arched window, the shade assembly comprising in combination:
a shade having a first end and second end, said shade including means for variably spacing said first end from said second end; and
means for holding said shade in a fanned configuration.

37- The shade assembly of claim 36 wherein said means for holding includes a support, said support having a base and at least one means for buttressing said shade by contacting said shade when said shade moves away from a position adjacent said window, said means for buttressing said shade extending up from said base.

38- The shade assembly of claim 37 wherein said means for buttressing said shade includes at least one substantially rigid panel extending up from said base.

39- The shade assembly of claim 38 wherein said means for holding said shade includes a retainer including said base extending horizontally and at least two panels including a front panel formed of rigid material extending vertically up from said base and a rear panel formed of rigid material extending up from said base, said rear panel parallel with said front panel, said rear panel spaced from said front panel by a distance at least as great as a thickness of said shade.

40- The shade assembly of claim 36 wherein said shade assembly includes a means for aligning said shade to exhibit a contour corresponding with a contour of the window adjacent said shade assembly.

41- The shade assembly of claim 40 wherein said means for aligning said shade includes a support, said support having a substantially horizontal base with a hump extending up from said base to a curved surface.

42- The shade assembly of claim 41 wherein said curved surface of said hump is circular in cross-section.

43- The shade assembly of claim 41 wherein said curved surface exhibits a curve with a cross-section which matches a contour of the window.

44- The shade assembly of claim 36 wherein said means for variably spacing said first end from said second end includes a plurality of pleats between substantially planar surfaces within said shade and said shade formed from sufficiently flexible material that an angle of planar surfaces adjacent each pleat can be changed with said pleats holding adjacent said planar surfaces to each other.

45- A support for a shade deployed in a fanned configuration, the support comprising in combination:
a horizontal base; and
at least one guide extending up from said base and adapted to hold said shade deployed within a vertical plane and in a fanned configuration with ends of the shade oriented horizontally substantially co-planar and at least partially adjacent the base.

46- The support of claim 45 wherein said support includes at least two guides oriented parallel to each other with a slot therebetween.

47- The support of claim 46 wherein said support is in the form of a retainer with said at least two guides configured as front and rear panels of rigid material extending vertically up from said horizontal base.

48- The support of claim 47 wherein said front panel and said rear panel each include a curved rim defining an uppermost portion of each of said panels.

49- The support of claim 47 wherein at least one of said front and rear panels is formed of at least partially transparent material.

50- The support of claim 47 wherein a hump is located upon said base and between said front panel and said rear panel at a midpoint between ends of said base extending between said front panel and said rear panel, said hump having a surface raised above said base.

51- The support of claim 50 wherein said hump includes a top surface having a circular cross-section.

52- The support of claim 50 wherein said top surface of said hump has a curving cross-section exhibiting a curve which corresponds with a curve exhibited by the window to be shaded by said apparatus.

53- The support of claim 45 wherein a hump is located upon said base and between said front panel and said rear panel at a midpoint between ends of said base extending between said front panel and said rear panel, said hump having a surface raised above said base.

54- The support of claim 53 wherein said hump includes a top surface having a circular cross-section.

55- The support of claim 53 wherein said top surface of said hump has a curving cross-section exhibiting a curve which corresponds with a curve exhibited by the window to be shaded by said apparatus.

56- The support of claim 45 wherein said support is in the form of a retainer having said at least one guide in the form of a front panel, said front panel extending vertically up from an edge of said base most distant from the window, said base having a width at least as great as a width of the shade, such that the shade can be located between said front panel and said window.

57- The support of claim 56 wherein said front panel and said rear panel each include a curved rim defining an uppermost portion of each of said panels.

58- The support of claim 56 wherein said retainer includes a rear panel extending vertically up from an edge of said base opposite said front panel with said rear panel parallel with said front panel and spaced from said front panel by a distance at least as great as a thickness of said shade.

59- The support of claim 56 wherein at least one of said front and rear panels is formed of an at least partially transparent material.

60- A method for at least partially occluding light passing through an arched window having a horizontal sill below the window, including the steps of:
providing a shade having a first end adapted to be spaced a variable distance from a second end and an inside edge and an outside edge defining sides of the shade from the first end to the second end;
providing a support having a horizontal base and at least one guide extending up from the base;
locating the support with the base adjacent the sill and with the guide parallel to the window and spaced from the window at least as far as a thickness of the shade;
orienting the shade in a fanned configuration with the first end and the second end substantially co-planar; and
placing the shade between the guide and the window with the ends of the shade at least partially adjacent the base of the support.

61- The method of claim 60 including the further step of cutting the shade to have a length from the inside edge to the outside edge that is at least as small as a radius of the arched window.

62- The method of claim 60 including the further step of providing a hump extending up from the base, the hump having a curved surface with a substantially circular cross-section.

63- The method of claim 62 including the further step of providing at least one of the ends of the shade with a rule having gradations thereon with indicia adjacent at least some of the gradations, the gradations and indicia corresponding with a radius of the arched window which will be covered when the shade is cut at that gradation.

64- The method of claim 60 including the further step of fastening the first end and the second end to the base.

65- The method of claim 64 including the further step of providing an adhesive on the first end and the second end of the shade, the adhesive sufficiently strong to hold the first end and the second end of the shade to the base of the support.

66- The method of claim 65 including the further step of fastening the base to the sill with the at least one guide of the support oriented substantially parallel with the window.
